(19) United States
(12) Patent Application Publication
(10) Pub. No.: US 2024/0146982 A1
(43) Pub. Date: May 2, 2024

(54) DELIVERY OF ENCRYPTED MULTIPLEXES VIA HYPER TEXT TRANSFER PROTOCOL

(71) Applicant: ARRIS Enterprises LLC, Suwanee, GA (US)

(72) Inventors: Erik J. Elstermann, Carlsbad, CA (US); Todd T. Kassman, Encinitas, CA (US); Michael A. Casteloes, Poway, CA (US); Mark L. Schaffer, Carlsbad, CA (US); John R. Shumate, Encinitas, CA (US); Robert L. Seymour, La Jolla, CA (US)

(73) Assignee: ARRIS Enterprises LLC, Suwanee, GA (US)

(21) Appl. No.: 18/376,223

(22) Filed: Oct. 3, 2023

Related U.S. Application Data
(63) Continuation of application No. 16/839,993, filed on Apr. 3, 2020, now abandoned.
(60) Provisional application No. 62/829,603, filed on Apr. 4, 2019.

(51) Int. Cl. H04N 21/236; H04L 65/612; H04N 7/167; H04N 21/2389; H04N 21/242; H04N 21/426; H04N 21/845

(52) U.S. Cl. CPC H04N 21/23608; H04L 65/612; H04N 7/1675; H04N 21/23895; H04N 21/242; H04N 21/426; H04N 21/8456

(57) ABSTRACT

A method and system provide the ability to deliver media content. A packager receives an original encrypted transport stream, and segments the stream into multiple fixed-duration transport stream files (chunks). The packager further generates a manifest file that describes the chunks and is consistent with a hypertext transfer protocol (HTTP) live streaming (HLS) protocol. The manifest file and chunks are delivered to a content delivery network (CDN). An enhanced HLS client is embed in an integrated receiver decoder (IRD). The enhanced HLS client retrieves the manifest file and the chunks from the CDN, and reconstructs the original encrypted transport stream for use by a service provider network.

### CROSS-REFERENCE TO RELATED APPLICATIONS

This application claims benefit of U.S. Provisional Patent Application No. 62/829,603, entitled “Delivery of DigiCipher Multiplexes via HTTP,” by Erik J. Elstermann, Todd T. Kassman, Michael A. Casteloes, Mark Schaffer, John Shumate, and Robert Lovejoy Seymour filed Apr. 4, 2019, which application is hereby incorporated by reference herein.

### BACKGROUND

### 1. Field

The present disclosure relates to systems and methods for delivering encrypted transport streams, and in particular to a system and method for delivering encrypted transport streams via both radio frequency (RF)/satellite and internet protocol (IP).

### 2. Description of the Related Art

Encrypted media content is often delivered to various recipients in transport streams via satellite. However, due to the cost and infrastructure required to maintain satellite based distribution, it is desirable to use alternative distribution mechanisms. Prior art systems fail to provide the ability to leverage the same/existing infrastructure while simultaneously delivering encrypted transport streams via multiple different network sources such as radio frequency (RF)/satellite and internet protocol (IP). To better understand these problems, a description of prior art content distribution systems may be useful.

FIG. 1 illustrates an overview of a distribution system of the prior art. Content 102 (e.g., television programs) is encoded by encoder 104, encrypted by encryptor 106 (e.g., a DIGICIPHER or MEDIACIPHER encryptor), and multiplexed (combined) by multiplexer 108 to generate multi-program transport streams (MPTS) 110. To distribute the content, the MPTS 110 is modulated by modulator 112, transmitted to satellite 116 via uplink 114, and received via multiple downlink receivers 118A-118C for delivery (via IRDs 120) to end-users (“subscribers”) via MVPDs (multichannel video programming distributor) (also referred to as service provider networks 122A-C). Integrated receiver-decoders (IRDs) 120A-120C (collectively referred to as IRDs 120) are used to decrypt, decode, and in some cases, transcode content 102 for subscriber consumption. The broadcast network controller (BNC) 124 is used to manage the MVPD IRD network (i.e., the MVPD IRD network consists of IRDs 120A-C and MVPDs 122A-C) including service authorization and the format of content provided to MVPDs 122A-122C.

As described above, to secure the content and maintain access control and security, encryptor 106 encrypt the data consistent with DIGICIPHER or MEDIACIPHER encryption. DIGICIPHER (or DIGICIPHER II) (available from the assignee of the present application) is based on a sophisticated key hierarchy, data encryption standard (DES) encryption algorithms, and a secure hardware and firmware implementation of encryption security. Encryption/access control is applied separately to each service within an uplink encoding system. Different modes enable different levels of encryption/security with various different keys ensuring security at both the IRD level and program level (e.g., unit keys that are unique to each IRD 120A-120C, category keys that are unique to a category of IRDs 120A-120C, and program keys that are unique to each program of content 102).

As an alternative to the system depicted in FIG. 1, content 102 may be streamed via a system in compliance with the hypertext transfer protocol HTTP live streaming (HLS) protocol. In HLS, the content 102 is separated into a plurality of segments (hereinafter alternatively referred to as “chunks”) of the same temporal duration, each of which are received and played by a sink. The address of each of the media segments/chunks is included in a “manifest” (also referred to as a “playlist”) that is transmitted from the content source to the sink. For live streams, the manifest changes with time on a first in-first out (FIFO) basis, with older segments being dropped from the manifest to make room for newer segments. The manifest may describe different versions of each segment (e.g. different resolutions), so that the sink may adapt to changing transmission throughput by requesting segments of reduced resolution (hence reduced size) or increased resolution (hence increased size).

In view of the above, what is needed is a method and system that leverages existing distribution system infrastructure while distributing content via multiple different transmission mediums (e.g., via RF/satellite and IP).

### SUMMARY OF THE INVENTION

Embodiments of the invention overcome the problems of the prior art by segmenting an incoming encrypted transport stream (e.g., an MPEG-2 transport stream multiplex) delivered via RF/satellite as a multi-program transport stream (MPTS), or multiple single-program transport streams (SPTSs) derived from that multiplex, into fixed-duration transport stream files (“chunks”) consistent with the HLS protocol. In addition, embodiments of the invention generate manifests also consistent with the HLS protocol. A non-adaptive bit rate variant of HLS with encrypted transport stream packets and all IRD command and control is included in each chunk.

In addition, embodiments of the invention embed a variant of an HLS client (referred to as an enhanced HLS client) in each IRD. The enhanced HLS client retrieves the aforementioned manifests and TS chunks and re-constructs the original MPTS or SPTS for subsequent decryption, decoding, transcoding, and output operations.

### BRIEF DESCRIPTION OF THE DRAWINGS

Referring now to the drawings in which like reference numbers represent corresponding parts throughout:

FIG. 1 illustrates an overview of a distribution system of the prior art;

FIG. 2 illustrates a system level overview for delivering media content in accordance with one or more embodiments of the invention;

FIG. 3 illustrates an alternative view of a hybrid satellite/IP distribution system in accordance with one or more embodiments of the invention;

FIG. 4 illustrates a home service configuration utilized in accordance with one or more embodiments of the invention;

FIG. 5 illustrates a map for converting the elements of the MPTS to M-SPTS in accordance with one or more embodiments of the invention;

FIG. 6 illustrates the overview of the generation of a segment file (e.g., MPTS to SPTS for one service) in accordance with one or more embodiments of the invention;

FIG. 7 illustrates an exemplary generation of a segment file from MPTS to SPTS in accordance with one or more embodiments of the invention;

FIG. 8 illustrates the system synchronization using NTP in accordance with one or more embodiments of the invention;

FIG. 9 illustrates the publication of IP service information by the packager in accordance with one or more embodiments of the invention;

FIG. 10 illustrates such media publication in accordance with one or more embodiments of the invention;

FIG. 11 illustrates an exemplary distribution topology that enables fault protection and redundancy in accordance with one or more embodiments of the invention;

FIG. 12 illustrates an exemplary uplink configuration in accordance with one or more embodiments of the invention;

FIG. 13 illustrates the topology for IRD operation in accordance with one or more embodiments of the invention;

FIG. 14 illustrates an exemplary downlink configuration (pursuant to the exemplary uplink configuration of FIG. 12) in accordance with one or more embodiments of the invention;

FIG. 15 illustrates the logical flow for delivering media content in accordance with one or more embodiments of the invention; and

FIG. 16 is an exemplary hardware and software environment used to implement one or more embodiments of the invention.

### DETAILED DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### System Level Overview

Embodiments of the invention segment a moving picture experts group 2 (MPEG-2) transport stream (TS) multiplex delivered via RF/satellite as a multi-program TS (MPTS), or multiple single-program TSs (derived from the multiplex), into fixed-duration TS files (“chunks”) and generate manifests consistent with the HLS protocol. A non-adaptive bit rate variant of HLS with encrypted TS packets and all IRD command and control information is included in each TS file. In addition, a variant of an HLS client (i.e., an enhanced HLS client) is embedded in each IRD. The enhanced HLS client retrieves the manifests and TS chunks, and re-constructs the original MPTS or SPTS for subsequent decryption, decoding, transcoding, and output operations.

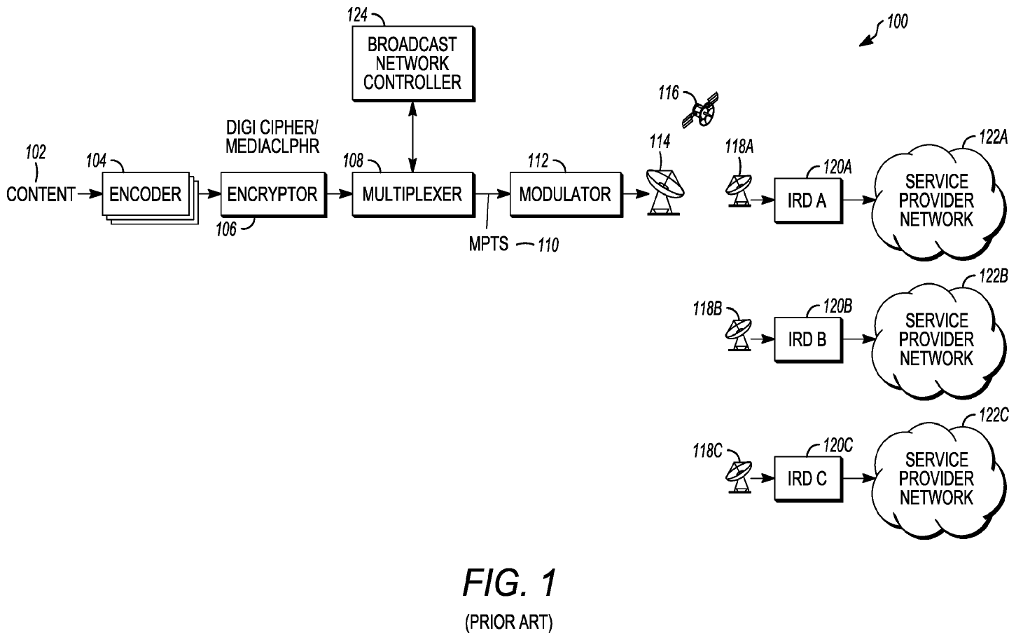

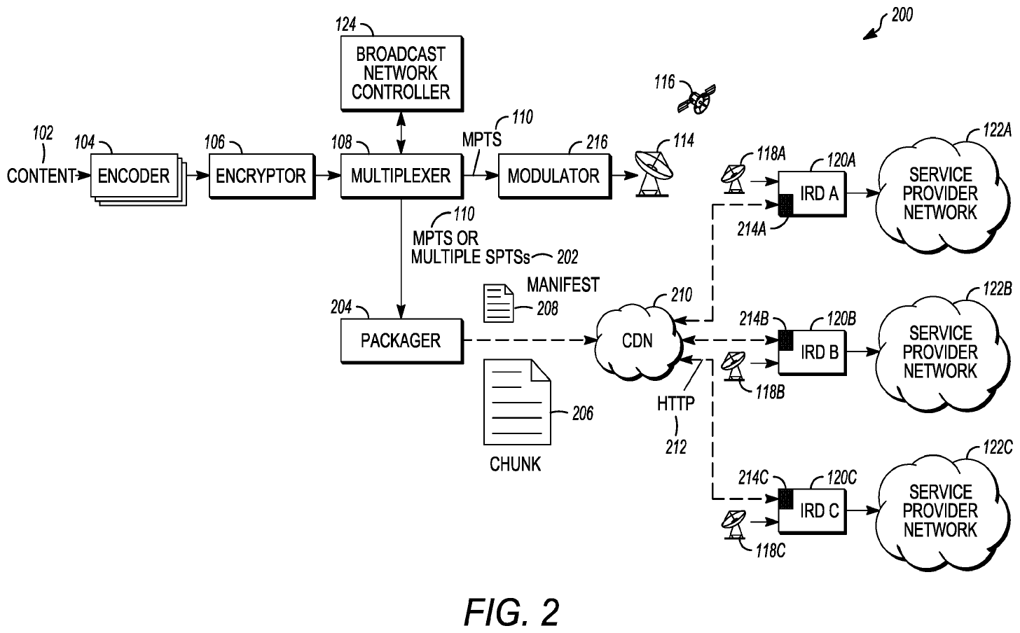

FIG. 2 illustrates a system level overview for delivering media content in accordance with one or more embodiments of the invention. Similar to FIG. 1, content 102 (e.g., television programs) is encoded by encoder 104, and encrypted by encryptor 106 (e.g., a DIGICIPHER or MEDIACIPHER encryptor), and multiplexed by multiplexer 108. However, in embodiments of the invention, the multiplexer 108 delivers either multi-program transport streams (MPTS) 110 or multiple single-program transport streams (SPTSs) 202 to packager 204. In alternative embodiments, the MPTS 110 and SPTS 202 are simultaneously generated and sent to packager 204. Thus, the packager 204 receives the encrypted multiplexed content (e.g., MPEG streams) from the multiplexer 108 in the form of live streams (MPTS/SPTS or both) and is configured to process those live streams for delivery over an IP (Internet Protocol) connection.

The packager 204 segments the real-time TS inputs into fixed duration (e.g., 2 to 10 seconds) transport stream (TS) files/“chunks” 206 (i.e., digestable files/chunks 206). The packager further generates “manifest” files 208 that describe the TS chunks 206 that comprise each multiplex. By utilizing the chunks 206 and manifest 208, the system 200 leverages the HLS (e.g., Internet Engineering Task Force [IETF] 8216) design and implementation that may be used in the distribution system.

The packager 204 routinely updates the manifest 208 and delivers the latest chunk file 206 to a content distribution network (CDN) 210 for IRD 120 consumption via HTTP/TCP networks 212. In view of the above, a non-adaptive bit rate variant of HLS may be used with encrypted TS packets and all IRD command and control included in each TS file 206. Specifically, all command and control information included in the multiplexes (from multiplexer 108) may be preserved by the packager 204. Accordingly, embodiments of the invention leverage existing network infrastructure requiring no customization of the CDN 210 provider or network.

An enhanced HLS client 214A-214C (collectively referred to as enhanced HLS client 214) is embed in each IRD 120A-120C respectively. The enhanced HLS client 214 retrieves chunks 206 and the manifest 208 (via the CDN 210) and reconstructs the original MPTS 110 or SPTS 202 for subsequent decryption, decoding, transcoding, and output operations. Specifically, the enhanced HLS client 214 may have the option of retrieving (or the packager may have the option of storing) the MPTS 110 or the SPTS 202 from/in the CDN 210 (e.g., in chunk format) (i.e., the MPTS 110 may be broken up into multiple SPTS 202 or the MPTS 110 may be retrieved by the IRDs 120). Thus, similar to satellite received transmissions, the chunks 206 may be received in MPTS 110 format. In addition, as the IRDs 120 are reconstructing the content (e.g., based on special syntax that facilitates the reconstruction), the packager 204 may discard/exclude extraneous/non-essential data when generating the chunks 206.

In one or more embodiments, the chunk 206 contents are encrypted at the TS packet level thereby eliminating the need for file-level protection (which is common with HLS). In this regard, the CDN 210 path is similar to and may utilize a similar algorithm, keys, and timing as the RF/satellite path.

Due to the packaging and configuration described herein, the IRDs 120 may be managed by the BNC 124 independent of the delivery medium (e.g., RF/satellite or IP/CDN 210). In this regard, the IRD 120 (via the enhanced HLS client 214) supports managed and autonomous switching of services between and within satellite 116 and CDN networks 210.

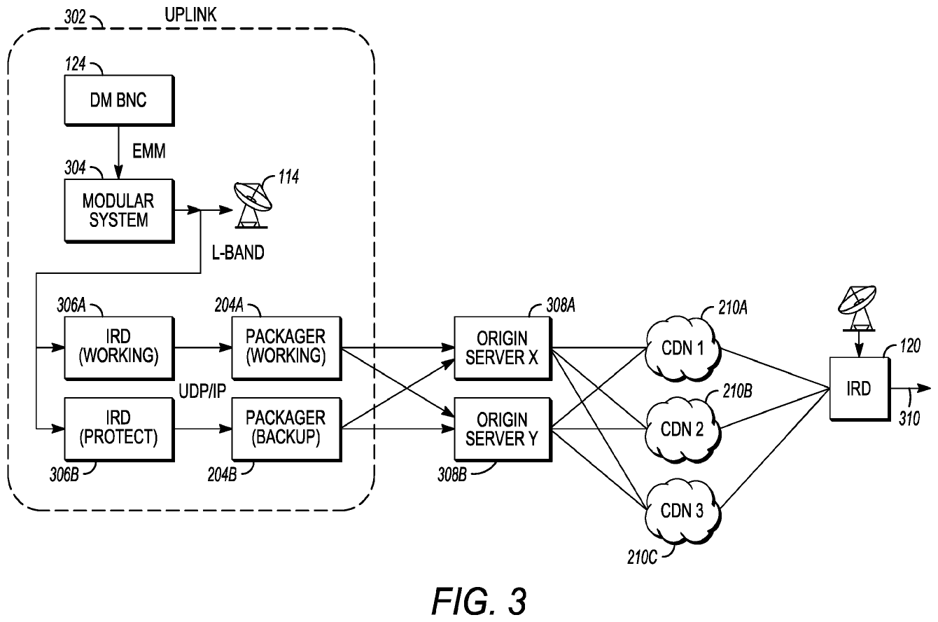

FIG. 3 illustrates an alternative view of a hybrid satellite/IP distribution system in accordance with one or more embodiments of the invention. As illustrated, the uplink system 302 includes the DM (decoder management) BNC 124 which is responsible for all commercial IRD equipment configuration and authorization (e.g., including forwarding EMMs [entitlement management messages] that are used to decode content on a per IRD basis). The uplink system 302 also includes modular system 304 (which may include the encrypter 106, multiplexer 108, and modulator 216). The uplink IRDs 306A (working IRD) and 306B (protect IRD) convert the modular system's live feed to multicast UDP/IP (user datagram protocol/internet protocol) delivered to the packagers 204 (i.e., working packager 204A and backup packager 204B). As described above, the packagers 204A and 204B convert the MPEG-2 TS to sequential segments/files/chunks 206 (e.g., MPTS to SPTSs [≤24] and MPTS to MPTS [M>1, Phase 2]). The origin servers 308A and 308B as well as the CDNs 210A-210C are provisioned for live streaming. The downlink IRD 120 retrieves the playlist/manifest 208 and segment files/chunks 206 from the CDNs 210 using HTTP. The downlink IRD 120 constructs MPEG compliant TS, decrypts, decodes, transcodes, and forwards 310 content to downstream equipment.

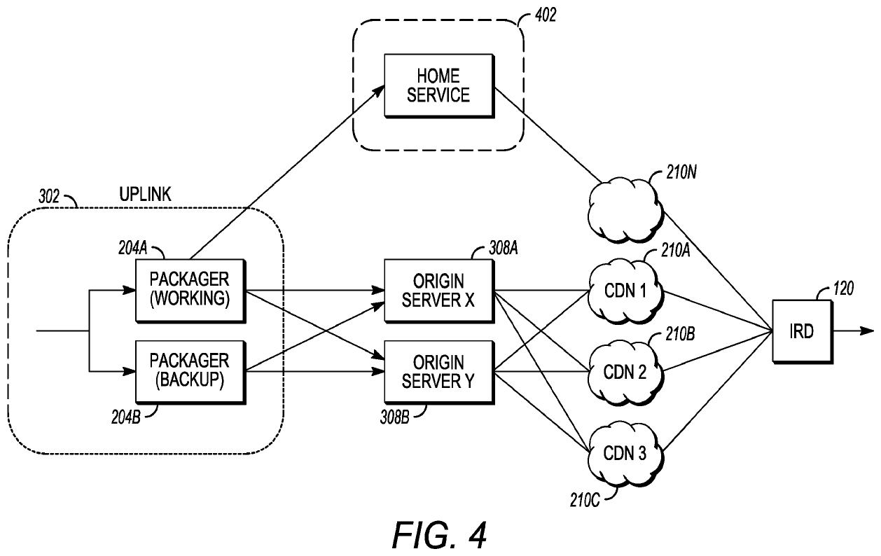

FIG. 4 illustrates a home service configuration utilized in accordance with one or more embodiments of the invention. The home service application 402 is used to distribute network information (e.g., IP service information) to IRDs 120 (via CDNs 210A-210N). Designated packagers 204 publish the IP service information to the home service 402. The home service 402 provides the IP service information when requested by the IRD 120. Additional home service 402 features may include IRD 120 health and status monitoring, CDN 210 performance monitoring, and IRD 120 code distribution. The packagers 204 and IRD 120 may employ TLS (Transport Layer Security) for secure communication with the home service application 402, while the packager 204 may be configured with home service 402 access credentials (e.g., username and password) to publish information for specific programmers.

### Packager 204 Details

The packager(s) 204 convert MPEG-2 TS input to file segments/chunks 206 (e.g., HLLS compliant chunks 206). In addition, packager(s) 204 generate playlist/manifests 208 for the associated file segments/chunks 206. In this regard, packager(s) 204 may receive MPTS 110 as input and may output MPTS. Alternatively, packager(s) 204 may receive MPTS 110 as input and may output SPTS (e.g., up to 24). Such an SPTS output may be preferred as only required services are delivered to the IRD 120, and a proprietary algorithm for TS file compression may help avoid unnecessary overhead. The packager(s) 204 may further embed NTP (network time protocol) time information in the file segments/chunks 206 which are used by NTP-synched IRDs 120 to perform disciplined local TS reconstruction. Input transport stream Program Clock References [PCRs] enable the synchronization of multiple packagers 204 (e.g., for the generation of identical file segments/chunks 206) such that there is seamless operation of IRDs 120 regardless of the packager 204 that the file segments/chunks 206 are generated from. In addition, the packager(s) 206 support the generation of IP service information to aid in IRD 120 service discovery.

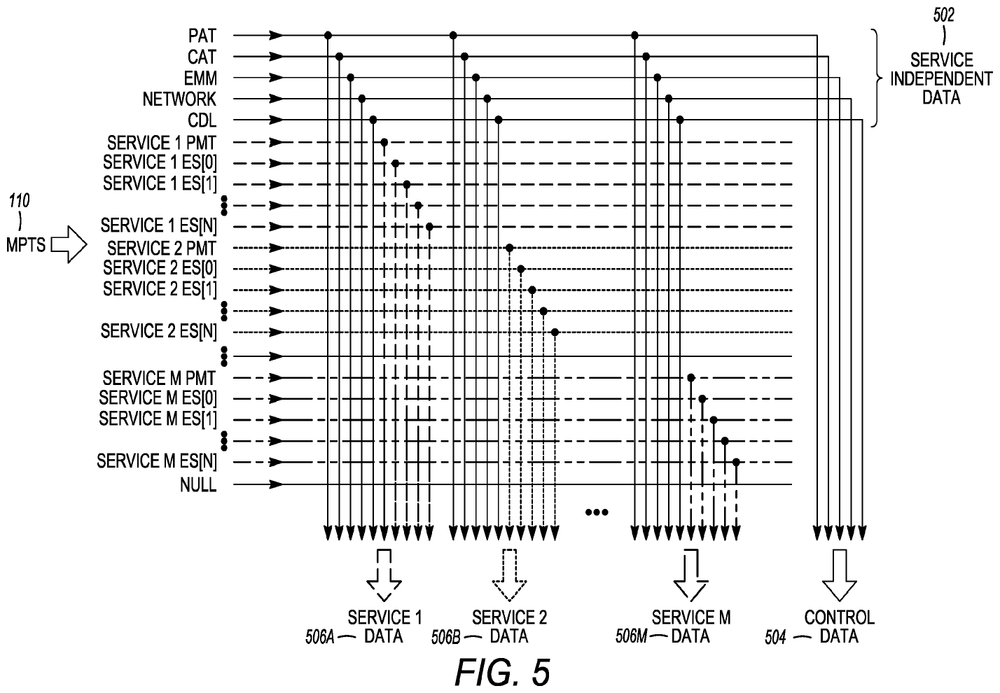

FIG. 5 illustrates a map for converting the elements of the MPTS to M-SPTS in accordance with one or more embodiments of the invention. The MPTS 110 includes service independent data 502 (e.g., PAT [program association table] that contains a directory listing of all program map tables, CAT [conditional access table] that contains a directly listing of entitlement management message streams used by program map tables, EMM [entitlement management message] data, network data/information, and CDL [code download] [for IRD firmware upgrades] information). The service-independent data 502 is converted into/used as the control data 504. Similarly, the MPTS 110 also includes the service information (i.e., service 1, service 2, and service M that is converted into/used as the service data 506 (i.e., service 1 data 506A, service 2 data 506B, service M data 506M, etc.). The MPTS transport stream has a concept of programs with every program (i.e., in the service information) described by a program map table (PMT). Each set of service information also includes multiple ESs (elementary streams) (i.e., ES[0] to ES[N]). ESs are usually the output of an audio encoder or video encoder and contains one kind of data (e.g., audio, video, or closed caption). As illustrated the MPTS 110 may be converted into multiple SPTS.

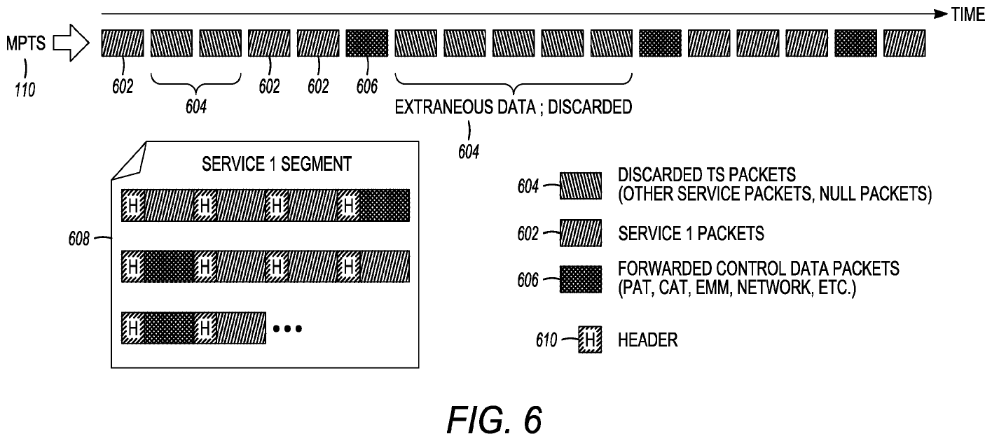

FIG. 6 illustrates the overview of the generation of a service segment file (e.g., MPTS to SPTS for one service) in accordance with one or more embodiments of the invention. As illustrated, the MPTS 110 includes the service 1 packets 602, discarded extraneous TS packets 604 (other service packets, null packets—that are considered extraneous data), and forwarded control data packets 606 (PAT, CAT, EMM, network, etc.). The output service 1 segment 608 includes the header 610 (for each packet) and the service 1 packets 602 and forwarded data control packets 606. The header includes header information (16 bits—bit 15 is the packager data flag, bit 0 is the TS packet from the packager TS input, and bit 1 is the TS packet inserted by the packager [e.g., packager generated information]), a packet count (16 bits)(i.e., an input TS packet instance), and an NTP time (64 bits) (i.e., the time at which the input TS packet is received by the packager).

The file format specified in the playlist for each segment may provide:
EXT-X-MEDIA-FORMAT=0: 188 bytes per TS packet (normal HLS, no header)
EXT-X-MEDIA-FORMAT=1: 200 bytes per TS packet

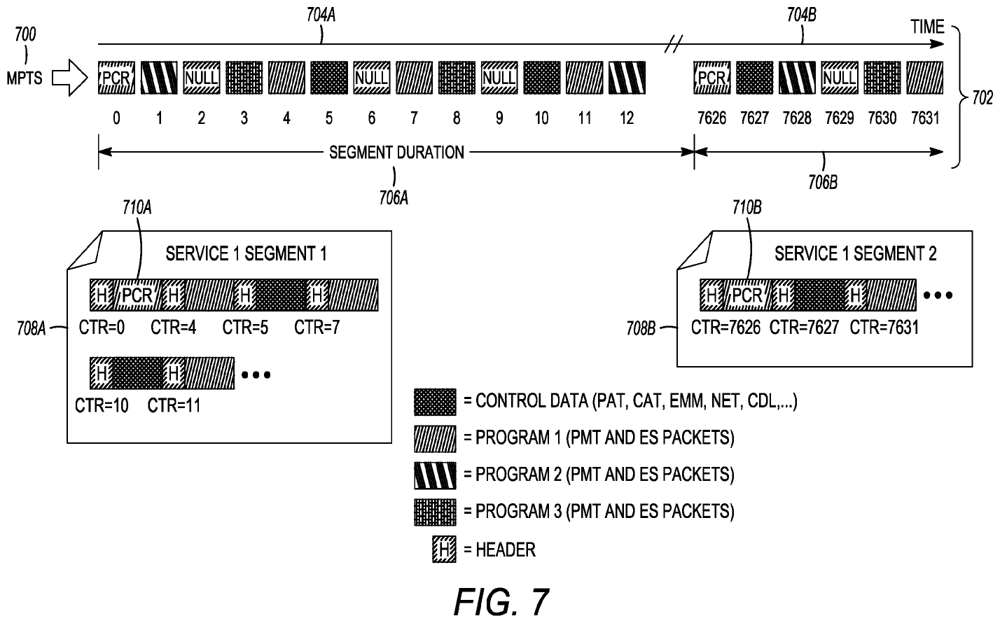

Once the segment file is received, the IRDs 120 reconstruct the original packet timing. FIG. 7 illustrates an exemplary generation of a segment file from MPTS to SPTS in accordance with one or more embodiments of the invention. The MPTS 700 is received with multiple programs in the transport stream as illustrated in area 702. Each file segment 704A and 704B is of a defined segment duration 706A and 706B respectively. Thus, the MPTS 700 consists of multiple programs in the transport stream. As illustrated, the MPTS is converted into multiple single program transport streams (SPTS) with each program in multiple file segments 708A and 708B (e.g., program 1 segment 1 708A and program 1 segment 2 708B). Similar segment files 708 would result for additional programs (e.g., programs 2 and 3) with the PCR (program clock reference) 710 as the first packet in each segment file 708.

Further, the packager 204 is responsible for generating the playlist/manifest that indicates the location and metadata for each TS segment. The playlist/manifest may be updated every “segment duration” sections (which may be configurable—e.g., 2-10 seconds in 1 second increments, with a default=4 seconds). In one or more embodiments, the number of TS segments referenced by the playlist may have a maximum (moving window) that is user-configurable (e.g., 5-40 segments; default=40). A new segment may be generated and published every “segment duration” seconds, when the media sequence number increments. The segment file name may also include the PCR value to guarantee synchronization of packager instances processing the same input program. Table A illustrates exemplary segment attributes:

TABLE A

| Segment Duration: | 4 seconds | | | | |
|---|---|---|---|---|---|
| Time: | 10:09:01.000 | 10:09:01.033 | 10:09:01.067 | 10:09:01.100 | 10:01:01.133 |
| Program PCR: | 538160783 | 539061683 | 539962583 | 540863483 | 541764383 |
| PCR/27000000 × 4: | 4.9830 | 4.9913 | 4.9997 | 5.0080 | 4.0163 |
| Media Sequence | 4 | 4 | 4 | 5 | 5 |
| Number: | | | | | |

When the media sequence number changes to five (5), it signals the start of a new segment, and segment four (4) is published. Using the information from Table A, the filename for segment 5 is: 540863483.ts.

The maximum media sequence number may be included in the playlist to help the IRD identify the rollover segment (a shortened segment may occur at PCR rollover (e.g., approx. every 26.5 hours).

Returning to FIGS. 3 and 4, the packager(s) 204 publish the playlist and segment files to a specific origin server 308 file location. Thereafter, the CDN 210 offers the files through URLs (which may be subject to change). The IRD 120 tunes to the playlist in the CDN 210 (i.e., at the published location), and retrieves the locations of the segments from the playlist (where the path for each segment may be relative to the playlist).

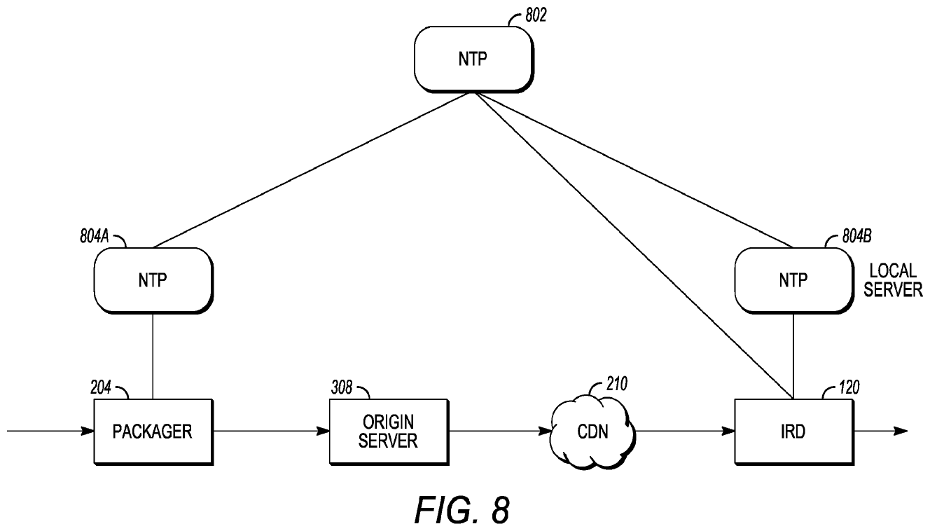

FIG. 8 illustrates the system synchronization using NTP in accordance with one or more embodiments of the invention. In this regard, for broadcast-quality service distribution, the packager 204 and IRD 120 may be required to synchronize to a common system time (e.g., NTP) 802. The IRD 120 MPEG clock may be disciplined by the NTP 802 to control TS playout (e.g., via the NTP 804A that disciplines the packager 204, and NTP 804B (on the local server) that disciplines the IRD 120 (NTPs 804 are controlled via NTP 802 to ensure synchronization). However, if the IRD 120 processes L-band input containing a different system time (e.g., DCII time), and NTP time service is unavailable, the different system time may be used as an alternate time service for synchronization.

Home Service

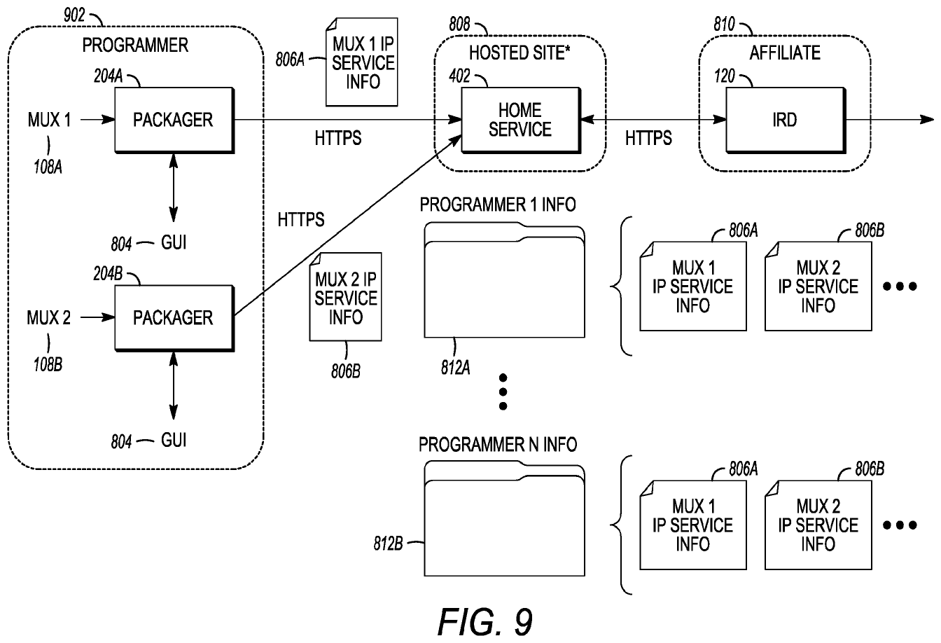

FIG. 9 illustrates the publication of IP service information by the packager 204 in accordance with one or more embodiments of the invention. The programmer 902 specifies IP service information for the mulitplexers/Mux 1108A and Mux 2 108B through the Packager GUI 804. The packager 804 then publishes the Mux IP service info 806A and 806B to a specific Home Service 402 account (e.g., within a hosted site 808 such as AWS). The IRD 120 (maintained by an affiliate 810) retrieves the IP service info 806 (in general or Programmer-specific) from the Home Service 402 (e.g., using a REST API). As illustrated, the programmer-specific information 812A and 812B provide the Mux service information 806A and 806B on a per programmer basis. Further, the Home Service 402 URL may be hard-coded in IRD 120 firmware. The IP service information 806 is used by the IRD 120 to identify an IP stream and its association with a Modular System service. The IP service information 806 may include modular system service information, playlist URL(s), latency information, and an optional service name. The modular system service information may include a virtual channel table ID, a virtual channel number, an MPEG program, and a control stream indication.

The communications between the packagers 204, home service 502, and IRD 120 may be secured using HTTPS where the home service (server) 402 is certificated, the IRD 120 firmware and packager (client) 204 employ Trusted CA certificates, and valid credentials are required to publish the packager info to specific home service programmer accounts.

Further embodiments that utilize the home service 502 may provide that the IRD 120 includes a unit address in GET requests that is used to target information delivered to the IRD 120. Further, IRD 120 firmware may support the delivery of health and status information to the home service 502, including information about network performance. Additional embodiments may also enable the distribution of code upgrades via the home service 502.

Publication

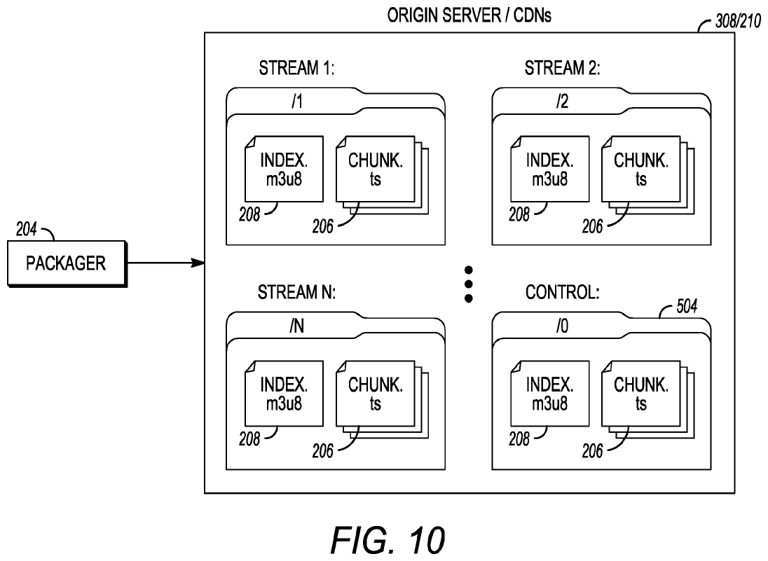

As described above, the packager(s) 204 publish the playlist and segment files to a specific origin server 308 file location. FIG. 10 illustrates such media publication in accordance with one or more embodiments of the invention. The chunks/file segments 206 and playlist/manifests 208 are published at URLs via the origin servers 308 and CDNs 210. For example, the playlist 208 may be published at playlist=“http://a.cdn.example.com:9000/hls/2/index.m3u8”, while the segment/chunk 206 may be published at segment=“http://a.cdn.example.com:9000/hls/2/chunk.ts”. The control stream 504 may be used for the initial IRD 120 installation but may be used permanently if other streams do not include control PIDs (packet identifiers).

Fault Protection and Redundancy

Returning to FIGS. 3 and 4, the TS input from the IRDs 306 may be passed to multiple packagers 204 (e.g., a working packager 204A and a backup packager 204B). As illustrated, the packagers 204 support multiple origin servers 308. Similarly, the IRD 120 supports multiple playlist URLs (e.g., with the various CDNs 210) per video service. Multiple CDNs 210 (hence, multiple URLs) may be used to distribute content for a service. In this regard, an additional URL may be typically used for maintenance and/or CDN 210 migration.

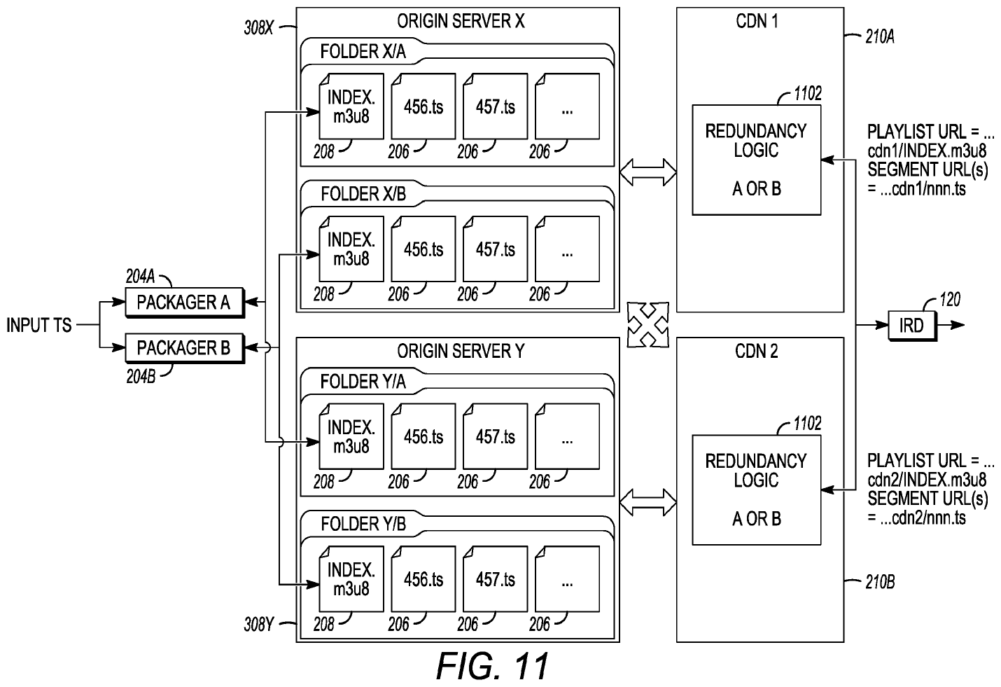

FIG. 11 illustrates an exemplary distribution topology that enables fault protection and redundancy in accordance with one or more embodiments of the invention. Packagers 204A and 204B support the two origin servers 308X and 308Y that communicate with two CDNs 210A and 210B. the origin servers 308X and 308Y maintain the same playlist/manifest files 208 and segments 206 in folders. The IRD 120 retrieves the playlist 208 and segments 206 via different URLs of the CDNs 210A/210B. Each URL provides the same playlist 208 and segments 206 from the origin servers 308X and 308Y. Accordingly, the redundancy in the origin servers 308X/308Y and redundancy logic 1102 in CDNs 210A and 210B provide the necessary fault protection and enable the IRD 120 to reconstruct the data regardless of the origin server 308/CDN 210 used to convey the data.

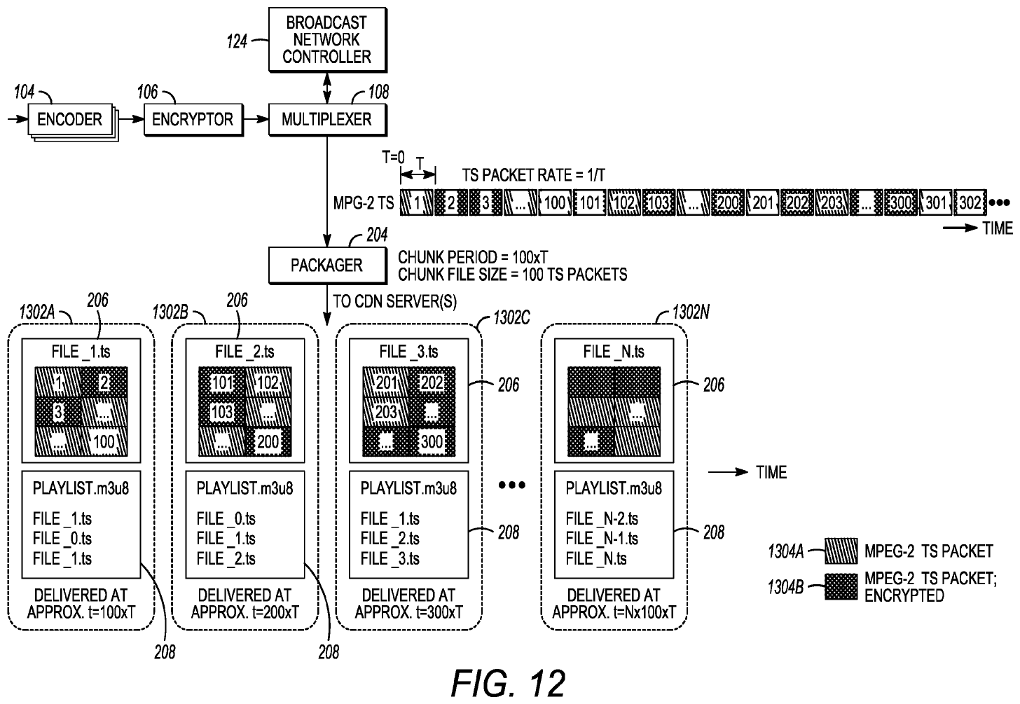

In view of the above, FIG. 12 illustrates an exemplary uplink configuration in accordance with one or more embodiments of the invention. As illustrated, the packager 204 receives the MPEG-2 TS with a particular packet rate (e.g., 1/T) and generates the different packages 1302A-1302N (that include both segment files 206 and playlists/manifests 208) to the CDN servers (for retrieval by IRDs 120). The file segments 206 may be in compliance with control information (e.g., a particular chunk period [e.g., 100×T]). Once generated, the different segment files 206 may include MPEG-2 TS packets 1304 including unencrypted packets 1304A and encrypted packets 1304B.

### IRD Operation

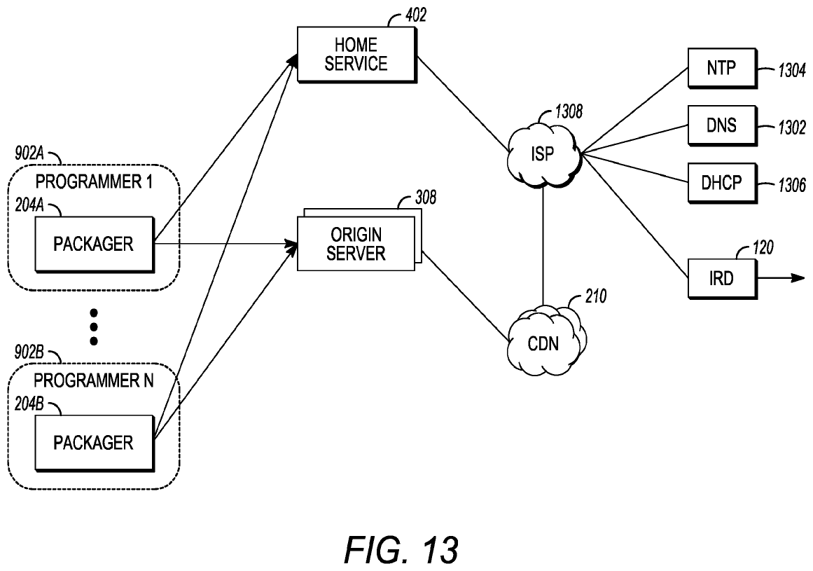

FIG. 13 illustrates the topology for IRD operation in accordance with one or more embodiments of the invention. The IP address, mask, gateway, DNS IP address(es) 1302, and NTP (network time protocol) IP address(es) 1304 may be configured through DHCP (dynamic host configuration protocol) 1306 (enabled by default on Ethernet-1 interface) or manually. The IRD 120 fetches programmer information from the home service 402 via an internet connection (e.g., an Internet Service Provider [ISP]) at a fixed domain. The operator may select the desired programmer 902A/902B and tune to a specified programmer's control stream to obtain authorization and configuration. The IRD 120 may also be manually tuned to a virtual channel advertised by the selected programmer.

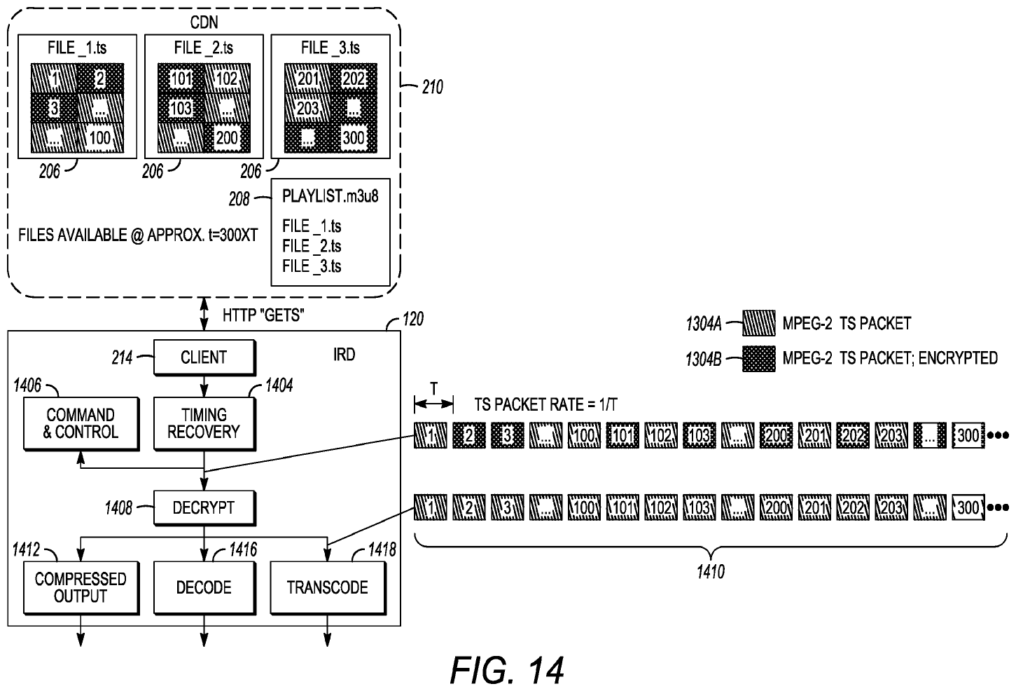

In view of the above, FIG. 14 illustrates an exemplary downlink configuration (pursuant to the exemplary uplink configuration of FIG. 12) in accordance with one or more embodiments of the invention. The IRD 120 retrieves (e.g., via an HTTP “GET” operation) the desired TS (including playlist/manifest 208 and segment files 206) from CDN 210. Such a retrieval is controlled via an enhanced HLS client 214 on the IRD 120. The client 214 retrieves the TS stream that includes encrypted packets 1304B. The timing recovery information 1404 and command and control information 1406 are preserved in the TS stream. The encrypted packets 1304B are decrypted at 1408 (resulting in TS 1410). The IRD 120 then forwards the compressed output 1412, and performs decoding 1416 and transcoding 1418 operations before passing the TS to a service provider network 122.

### Exemplary Use Cases

As described above, the standard use case is that of having the IRD 120 process media streams that are encrypted and generated by the packager 204, and retrieved from the CDN 210 in real time.

In one or more alternative embodiments, the media stream may be pre-multiplexed, created, and published to the CDN 210. Thus, the IRD 120 has the opportunity to not only process media streams that are encrypted and generated by the packager 204 in real time, but also the opportunity to pull streams that have been generated in non-real time and published and posted on the CDN 210 for later use. In such embodiments, a programmer may desire to inject local/regional advertisements for a particular IRD 120, and may provide instructions to the IRD 120 to retrieve chunks (including particular advertisements) from a specific URL that contains such advertisements. In this regard, the programmer may place such local/regional advertisements in the CDN 210 and as a result, the programmer may have the ability to receive advertising revenue.

In yet another embodiment, a set of content may only be intended for a certain geographic region or a certain time of day (e.g., after a sports program/show). Such content may be pre-encrypted and published to the CDN 210. Thereafter, IRDs 120 in a particular market or within a particular time frame may be instructed to retrieve the set of content from the CDN 210.

### Logical Flow

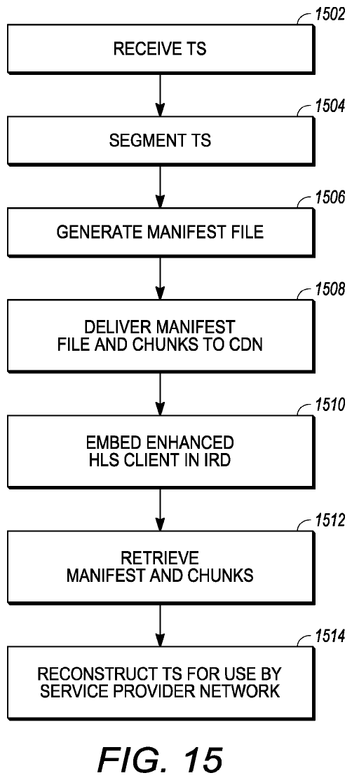

FIG. 15 illustrates the logical flow for delivering media content in accordance with one or more embodiments of the invention.

At step 1502, the packager receives an original encrypted transport stream (e.g., an MPTS or SPTS stream).

At step 1504, the packager segments the original encrypted transport stream (TS) into multiple fixed-duration TS files (i.e., chunks). In one or more embodiments, the multiple fixed-duration TS files are encrypted at a TS packet level. Further, the packager may embed NTP time information in the multiple fixed-duration transport TS such that the IRD is NTP-synched and the NTP time information is used to discipline local TS reconstruction. In one or more embodiments, input program clock references (PCRs) in the original encrypted transport stream are used to enable synchronization of the packager and one or more additional packagers (i.e., such that the packager and the one or more additional packagers generate identical multiple fixed-duration transport stream files). In this regard, each of the multiple fixed-duration transport stream files may be generated and published at predefined time durations, while a name of each of the multiple fixed-duration transport stream files includes a value of the PCR for the synchronization.

In addition, the packager may discard extraneous data from the original encrypted TS before segmenting the original TS into the multiple fixed-duration TS files. In this regard, the extraneous data may include packets that are not essential for the enhanced HLS client to reconstruct the original encrypted TS. Of note is that the packager may preserve the command and control information from/in the original encrypted TS.

At step 1506, the packager generates a manifest file that describes the multiple fixed-duration TS files. The manifest file is consistent with a HTTP live streaming (HLS) protocol.

At step 1508, the manifest file and the multiple fixed-duration TS files are delivered to/onto a content delivery network (CDN).

At step 1510, an enhanced HLS client is embed in an IRD.

At step 1512, the enhanced HLS client retrieves the manifest file and the multiple fixed-duration TS files from the CDN.

At step 1514, the enhanced HLS client reconstructs the original encrypted TS for use by a service provider network.

In one or more embodiments, the manifest file and multiple fixed-duration TS files are delivered and published to the CDN, while an advertisement may also be inserted into the CDN such that the enhanced HLS client retrieves the advertisement. Alternatively or in addition, the manifest files and the multiple fixed-duration TS files are delivered and published to the CDN for a particular geographic region. In such an embodiment, once a determination has been made that the enhanced HLS client is within the particular geographic region, the enhanced HLS client retrieves the manifest files and multiple fixed-duration TS files for the particular geographic region (e.g., from a particular URL in the CDN).

### Hardware Environment

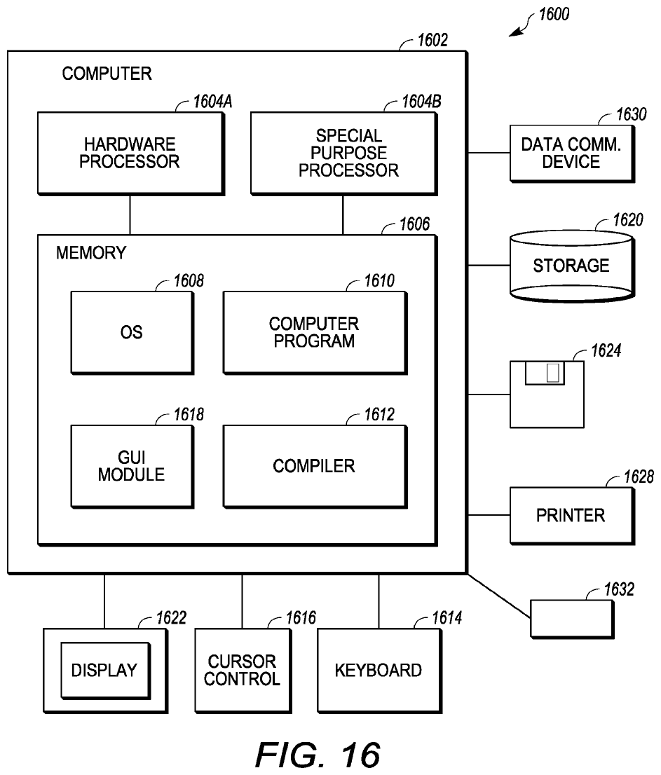

FIG. 16 is an exemplary hardware and software environment 1600 (referred to as a computer-implemented system and/or computer-implemented method) used to implement one or more embodiments of the invention. The hardware and software environment includes a computer 1602 and may include peripherals. Computer 1602 may be a user/client computer, server computer, database computer, IRD, packager, uplink system, downlink system, etc. The computer 1602 comprises a hardware processor 1604A and/or a special purpose hardware processor 1604B (hereinafter alternatively collectively referred to as processor 1604) and a memory 1606, such as random access memory (RAM). The computer 1602 may be coupled to, and/or integrated with, other devices, including input/output (I/O) devices such as a keyboard 1614, a cursor control device 1616 (e.g., a mouse, a pointing device, pen and tablet, touch screen, multi-touch device, etc.) and a printer 1628. In one or more embodiments, computer 1602 may be coupled to, or may comprise, the uplink system 1632 (e.g., including an encoder, encrypter, multiplexer, broadcast network controller, and/or packager). In yet another embodiment, the computer 1602 may comprise an IRD (or may be part of a downlink system) or may be coupled to a CDN or other network.

In one embodiment, the computer 1602 operates by the hardware processor 1604A performing instructions defined by the computer program 1610 (e.g., packager operations, or an enhanced HLS client on an IRD) under control of an operating system 1608. The computer program 1610 and/or the operating system 1608 may be stored in the memory 1606 and may interface with the user and/or other devices to accept input and commands and, based on such input and commands and the instructions defined by the computer program 1610 and operating system 1608, to provide output and results.

Output/results may be presented on the display 1622 or provided to another device for presentation or further processing or action. In one embodiment, the display 1622 comprises a liquid crystal display (LCD) having a plurality of separately addressable liquid crystals. Alternatively, the display 1622 may comprise a light emitting diode (LED) display having clusters of red, green and blue diodes driven together to form full-color pixels. Each liquid crystal or pixel of the display 1622 changes to an opaque or translucent state to form a part of the image on the display in response to the data or information generated by the processor 1604 from the application of the instructions of the computer program 1610 and/or operating system 1608 to the input and commands. The image may be provided through a graphical user interface (GUI) module 1618. Although the GUI module 1618 is depicted as a separate module, the instructions performing the GUI functions can be resident or distributed in the operating system 1608, the computer program 1610, or implemented with special purpose memory and processors.

In one or more embodiments, the display 1622 is integrated with/into the computer 1602 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 1602 according to the computer program 1610 instructions may be implemented in a special purpose processor 1604B. In this embodiment, some or all of the computer program 1610 instructions may be implemented via firmware instructions stored in a read only memory (ROM), a programmable read only memory (PROM) or flash memory within the special purpose processor 1604B or in memory 1606. The special purpose processor 1604B may also be hardwired through circuit design to perform some or all of the operations to implement the present invention. Further, the special purpose processor 1604B may be a hybrid processor, which includes dedicated circuitry for performing a subset of functions, and other circuits for performing more general functions such as responding to computer program 1610 instructions. In one embodiment, the special purpose processor 1604B is an application specific integrated circuit (ASIC).

The computer 1602 may also implement a compiler 1612 that allows an application or computer program 1610 written in a programming language such as C, C++, Assembly, SQL, PYTHON, PROLOG, MATLAB, RUBY, RAILS, HASKELL, or other language to be translated into processor 1604 readable code. Alternatively, the compiler 1612 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1610 accesses and manipulates data accepted from I/O devices and stored in the memory 1606 of the computer 1602 using the relationships and logic that were generated using the compiler 1612.

The computer 1602 also optionally comprises an external communication device such as a modem, satellite link, Ethernet card, or other device for accepting input from, and providing output to, other computers 1602 and/or devices as described herein.

In one embodiment, instructions implementing the operating system 1608, the computer program 1610, and the compiler 1612 are tangibly embodied in a non-transitory computer-readable medium, e.g., data storage device 1620, which could include one or more fixed or removable data storage devices, such as a zip drive, floppy disc drive 1624, hard drive, CD-ROM drive, tape drive, etc. Further, the operating system 1608 and the computer program 1610 are comprised of computer program 1610 instructions which, when accessed, read and executed by the computer 1602, cause the computer 1602 to perform the steps necessary to implement and/or use the present invention or to load the program of instructions into a memory 1606, thus creating a special purpose data structure causing the computer 1602 to operate as a specially programmed computer executing the method steps described herein. Computer program 1610 and/or operating instructions may also be tangibly embodied in memory 1606 and/or data communications devices 1630, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1602.

### CONCLUSION

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

In view of the above, embodiments of the invention leverage existing HTTP/TCP network infrastructure and are able to traverse most networks with no changes to routing/firewall configurations. Further, embodiments preserve the use of various conditional access/encryption systems to protect content delivered via IP. No changes to the uplink encoding, encryption, multiplexing, or IRD decoder management infrastructure are required, allowing the uplink programmer to manage their IRD network independent of transmission medium. One or more embodiments result in no impact to current or future IRD functionality following the embedding of the enhanced HLS client. In addition, embodiments are amenable to interoperability with 3^{rd} party DRM (digital rights management) systems (in which case content protection may be applied at the chunk/file level instead of the TS packet layer). Also, as HLS is supported by numerous content distribution network (CDN) providers, the cost/risk of deployment is very low for programmers.

1-22. (canceled)

23. A method of delivering media content, comprising:
receiving, in a packager, an original encrypted transport stream;
the packager segmenting the original encrypted transport stream into multiple fixed-duration transport stream files;
the packager generating a manifest file that describes the multiple fixed-duration transport stream files, wherein the manifest file is consistent with a hypertext transfer protocol (HTTP) live streaming (HLS) protocol;
delivering the manifest file and the multiple fixed-duration transport stream files to an enhanced HLS client device executing in an integrated receiver decoder (IRD);
the enhanced HLS client retrieving the manifest file and the multiple fixed-duration transport stream files from the CDN; and
the enhanced HLS client reconstructing the original encrypted transport stream and outputting the stream onto a service provider network that provides content to a plurality of subscriber devices.

24. The method of claim 23, wherein the encrypted transport stream that is received by the packager comprises a multi-program transport stream (MPTS).

25. The method of claim 23, wherein the multiple fixed-duration transport stream files comprise multiple single-program transport (STPS) streams.

26. The method of claim 23, wherein the multiple fixed-duration transport stream files are encrypted at a transport stream packet level.

27. The method of claim 23, wherein the packager preserves command and control information in the original encrypted transport stream.

28. The method of claim 23, wherein the packager embeds network time protocol (NTP) time information in the multiple fixed-duration transport stream files and the IRD is NTP-synched and the NTP time information is used to discipline local transport stream reconstruction.

29. The method of claim 23, further comprising enabling, using input program clock references (PCRs) in the original encrypted transport stream, synchronization of the packager and one or more additional packagers, wherein the packager and one or more additional packagers generate identical multiple fixed-duration transport stream files.

30. The method of claim 23, wherein each of the multiple fixed-duration transport stream files are generated and published at predefined time durations and a name of each of the multiple fixed-duration transport stream files includes a value of the PCR for the synchronization.

31. The method of claim 23, wherein the packager discards extraneous data from the original encrypted transport stream before segmenting the original encrypted transport stream into multiple fixed-duration transport stream files, wherein the extraneous data comprises packets that are not essential for the enhanced HLS client to reconstruct the original encrypted transport stream.

32. The method of claim 23, wherein the manifest file and the multiple fixed-duration transport stream files are delivered and published to the CDN, the advertisement is inserted into the CDN and the enhanced HLS client retrieves the advertisement.

33. The method of claim 23, wherein the manifest file and the multiple fixed-duration transport stream files are delivered and published to the CDN for a particular geographic region, the method further comprising:
determining that the enhanced HLS client is within the particular geographic region; and
the enhanced HLS client retrieving the manifest file and the multiple fixed-duration transport stream files for the particular geographic region.

34. A system for delivering media content, comprising:
(a) a packager comprising:
(i) an input for receiving an original encrypted transport stream;
(ii) a processor that causes the packager to:
(A) segment the original encrypted transport stream into multiple fixed-duration transport stream files; and
(B) generate a manifest file that describes the multiple fixed-duration transport stream files, wherein the manifest file is consistent with a hypertext transfer protocol (HTTP) live streaming (HLS) protocol;
(iii) an output for delivering the manifest file and the multiple fixed-duration transport stream files to a content delivery network (CDN);
(b) an integrated receiver decoder (IRD) comprising an enhanced HLS client executing on the IRD, wherein the enhanced HLS client:
(A) retrieves the manifest file and the multiple fixed-duration transport stream files from the CDN; and
(B) reconstructs the original encrypted transport stream and outputs the stream onto a service provider network that provides content to a plurality of subscriber devices.

35. The system of claim 34, wherein the encrypted transport stream that is received by the packager comprises a multi-program transport stream (MPTS).

36. The system of claim 34, wherein the multiple fixed-duration transport stream files comprise multiple single-program transport (STPS) streams.

37. The system of claim 34, wherein the multiple fixed-duration transport stream files are encrypted at a transport stream packet level.

38. The system of claim 34, wherein the packager preserves command and control information in the original encrypted transport stream.

39. The system of claim 34, wherein:
the processor causes the packager to embed network time protocol (NTP) time information in the multiple fixed-duration transport stream files; and
the IRD is NTP-synched and the NTP time information is used to discipline local transport stream reconstruction.

40. The system of claim 34, further comprising:
one or more additional packagers, wherein input program clock references (PCRs) in the original encrypted transport stream are used to synchronize the packager and one or more additional packagers, wherein the packager and one or more additional packagers generate identical multiple fixed-duration transport stream files.

41. The system of claim 40, wherein:
each of the multiple fixed-duration transport stream files are generated and published at predefined time durations; and
a name of each of the multiple fixed-duration transport stream files includes a value of the PCR for the synchronization.

42. The system of claim 34, wherein the processor causes the packager to discard extraneous data from the original encrypted transport stream before segmenting the original encrypted transport stream into multiple fixed-duration transport stream files, wherein the extraneous data comprises packets that are not essential for the enhanced HLS client to reconstruct the original encrypted transport stream.

43. The system of claim 34, wherein:
the manifest file and the multiple fixed-duration transport stream files are delivered and published to the CDN;
an advertisement is inserted into the CDN, wherein the enhanced HLS client further retrieves the advertisement.

44. The system of claim 34, wherein:
the manifest file and the multiple fixed-duration transport stream files are delivered and published to the CDN for a particular geographic region;
the IRD further:
determines that the enhanced HLS client is within the particular geographic region; and
the enhanced HLS client retrieves the manifest file and the multiple fixed-duration transport stream files for the particular geographic region.
